(19) United States
(12) Patent Application Publication
(10) Pub. No.: US 2019/0033519 A1
(43) Pub. Date: Jan. 31, 2019

(54) OPTICAL WAVEGUIDE

(71) Applicant: NITTO DENKO CORPORATION, Ibaraki-shi, Osaka (JP)

(72) Inventors: Yuichi Tsujita, Ibaraki-shi (JP); Norihiko Okamoto, Ibaraki-shi (JP)

(73) Assignee: NITTO DENKO CORPORATION, Ibaraki-shi, Osaka (JP)

(21) Appl. No.: 16/074,918

(22) PCT Filed: Feb. 7, 2017
(86) PCT No.: PCT/JP2017/004288

§ 371 Date: Aug. 2, 2018

(30) Foreign Application Priority Data
Mar. 17, 2016 (JP) 2016-053745

(51) Int. Cl. G02B 6/122; G02F 1/225

(52) U.S. Cl. CPC G02B 6/122; G02B 2006/12126; G02F 1/225

(57) ABSTRACT

The present disclosure provides an optical waveguide capable of enhancing the suppression of crosstalk. The optical waveguide includes: under claddings; cores for light propagation arranged in side-by-side relation on surfaces of the respective under claddings; over claddings covering the cores; and a light absorbing part provided between adjacent ones of the cores, the light absorbing part being in non-contacting relationship with the cores. The light absorbing part contains a light absorbing agent having an ability to absorb light propagating in the cores. The optical waveguide is produced on a surface of a substrate.

### TECHNICAL FIELD

The present disclosure relates to an optical waveguide for use in the fields of optical communications, optical information processing and other general optics.

### BACKGROUND ART

As shown in FIG. 13A in plan view and as shown in FIG. 13B in sectional view taken along the line C-C of FIG. 13A, an optical waveguide W13 in general includes: an under cladding 1; linear cores 2 for light propagation protruding in a predetermined pattern and formed on a surface of the under cladding 1; and an over cladding 3 formed on the surface of the under cladding 1 so as to cover the cores 2. The optical waveguide W13 is configured such that light enters a light entrance portion 2a disposed in a first end portion of each of the cores 2 and that the light exits a light exit portion 2b disposed in a second end portion of each of the cores 2. That is, light entering the light entrance portion 2a disposed in the first end portion of each core 2 is propagated in each core 2 to the light exit portion 2b disposed in the second end portion of each core 2 while being reflected repeatedly from an interface with the under cladding 1 and an interface with the over cladding 3 both not shown. In FIG. 13B, the reference numeral 5 designates a substrate for use in the production of the optical waveguide W13.

In the course of the production of the optical waveguide W13, there are cases in which foreign substances come into the cores 2 and in which the aforementioned interfaces are formed into rough surfaces. When light propagating in a core 2 impinges upon foreign substances present in the core 2, there are cases in which the light is reflected in an irregular direction. As a result, the light is not reflected from the interfaces but is transmitted through the interfaces (leaks from the core 2) (with reference to dash-double-dot arrows L1). When the interfaces are rough surfaces, there are cases in which light reaching the interfaces is not reflected from the interfaces but is transmitted through the interfaces (leaks from the core 2) (with reference to dash-double-dot arrows L2).

The aforementioned leakage of light from one of the cores 2 in the optical waveguide W13 including the cores 2 for light propagation arranged in side-by-side relation causes what is called “crosstalk” that is a situation in which the leaking light enters a core 2 adjacent to the one core 2. The light entering the adjacent core 2 is noise (N) for light (signal S) propagating in the adjacent core 2, and decreases the S/N ratio to make optical communications unstable.

To solve such a problem, an optical waveguide W14 has been proposed as shown in FIG. 14A in plan view and as shown in FIG. 14B in sectional view taken along the line D-D of FIG. 14A (see PTL 1, for example). In the optical waveguide W14, dummy cores 20 made of the same material as the cores 2 and not used for light propagation are provided between adjacent ones of the cores 2 for light propagation to thereby suppress crosstalk. Like the cores 2, the dummy cores 20 in this optical waveguide W14 have a refractive index higher than the refractive indices of the under cladding 1 and the over cladding 3. Based on this, this optical waveguide W14 has attempted to make light leaking from the cores 2 and entering the dummy cores 20 less prone to leak from the dummy cores 20, although not shown. For the purpose of clarifying the arrangement of the cores 2 and the dummy cores 20, the cores 2 and the dummy cores 20 are shaded by means of broken diagonal lines in FIG. 14A, and the diagonal lines for the dummy cores 20 are spaced more widely than those for the cores 2.

### RELATED ART DOCUMENT

### Patent Document

PTL 1: JP-A-2014-2218

### SUMMARY OF INVENTION

Unfortunately, most of the light leaking from the cores 2 in the conventional optical waveguide W14 including the dummy cores 20 is transmitted through the dummy cores 20 (with reference to dash-double-dot arrows L3 and L4), so that crosstalk is not sufficiently suppressed. That is, if the light leaking from the cores 2 enters the dummy cores 20, there often arises a problem such that the light leaks also from the dummy cores 20 for the same reason as the leakage of light from the cores 2.

In view of the foregoing, it is therefore an object of the present disclosure to provide an optical waveguide capable of enhancing the suppression of crosstalk.

An optical waveguide according to the present disclosure comprises: a plurality of cores for light propagation arranged in side-by-side relation; and a light absorbing part provided between adjacent ones of the plurality of cores, the light absorbing part being in a non-contacting relationship with the cores, wherein the light absorbing part contains a light absorbing agent having an ability to absorb light propagating in the cores.

The present inventors have made studies about the structure of an optical waveguide including a plurality of cores for light propagation arranged in side-by-side relation for the purpose of enhancing the suppression of crosstalk between the cores. In the course of the studies, the present inventors have hit upon the idea of providing a light absorbing part between adjacent ones of the cores. The light absorbing part shall contain a light absorbing agent having an ability to absorb light propagating in the cores. As a result, the present inventors have found out that, when light leaking from the cores impinges upon the light absorbing part, the light is absorbed by the light absorbing part and does not enter adjacent ones of the cores, so that the suppression of crosstalk can be enhanced. However, the present inventors have obtained findings that, when the light absorbing part is provided in contact with the cores, light propagating in the cores is absorbed and attenuated by the light absorbing part each time the light is reflected from an interface with the light absorbing part. That is, when the light absorbing part is in contact with the cores, the proper light propagation in the cores is not achieved even while the suppression of crosstalk can be enhanced. Thus, the present inventors have found that the provision of the light absorbing part in non-contacting relationship with the cores consequently achieves the proper light propagation in the cores as well as the enhancement of the suppression of crosstalk.

The optical waveguide according to the present disclosure includes the cores for light propagation arranged in side-by-side relation, and the light absorbing part provided between adjacent ones of the cores. The light absorbing part contains the light absorbing agent having the ability to absorb light propagating in the cores. Thus, light leaking from the cores impinges upon the light absorbing part to thereby be absorbed by the light absorbing part, and is prevented from entering adjacent ones of the cores. Therefore, the optical waveguide according to the present disclosure produces the effect of suppressing crosstalk. In addition, the light absorbing part in the optical waveguide according to the present disclosure is provided in non-contacting relationship with the cores. Thus, light propagating in the cores is prevented from being absorbed and attenuated by the light absorbing part, and is propagates in the cores.

In particular, in the case where the non-contacting relationship between the cores and the light absorbing part is established by a cladding surrounding the cores, the suppression of crosstalk is enhanced without high costs because the cladding is typically used in the optical waveguide.

In particular, in the case where the cladding is made of a resin, the non-contacting relationship between the cores and the light absorbing part is maintained with higher reliability. Thus, the attenuation of light propagating in the cores is prevented with higher reliability.

Further, in the case where the cladding is covered with the light absorbing part, the light absorbing part is capable of preventing light (disturbance light) coming from outside the optical waveguide according to the present disclosure from entering the cores with higher reliability.

Also, in the case where the cladding is made of air, a difference in refractive index between the cores and air (air cladding) is greater. This makes light propagating in the cores less prone to leak from the cores, thereby further enhancing the suppression of crosstalk.

### BRIEF DESCRIPTION OF DRAWINGS

FIG. 1A is a schematic plan view of an optical waveguide according to a first embodiment of the present disclosure; and FIG. 1B is a schematic sectional view taken along the line A-A of FIG. 1A.

FIGS. 2A to 2D are illustrations schematically showing a method of manufacturing the optical waveguide.

FIG. 3 is a schematic sectional view of the optical waveguide according to a second embodiment of the present disclosure.

FIG. 4 is a schematic sectional view of the optical waveguide according to a third embodiment of the present disclosure.

FIG. 5 is a schematic sectional view of the optical waveguide according to a fourth embodiment of the present disclosure.

FIG. 6 is a schematic sectional view of the optical waveguide according to a fifth embodiment of the present disclosure.

FIG. 7 is a schematic sectional view of the optical waveguide according to a sixth embodiment of the present disclosure.

FIG. 8A is a schematic plan view of the optical waveguide according to a seventh embodiment of the present disclosure; and FIG. 8B is a schematic sectional view taken along the line B-B of FIG. 8A.

FIG. 9 is a schematic sectional view of the optical waveguide according to an eighth embodiment of the present disclosure.

FIG. 10 is a schematic sectional view of a modification of the optical waveguide according to the seventh and eighth embodiments.

FIG. 11 is a schematic plan view of another modification of the optical waveguide according to the seventh and eighth embodiments.

FIG. 12A is a schematic plan view of a modification of the optical waveguide according to the first embodiment; and FIG. 12B is a schematic plan view of a modification of the optical waveguide according to the seventh embodiment.

FIG. 13A is a schematic plan view of a conventional optical waveguide; and FIG. 13B is a schematic sectional view taken along the line C-C of FIG. 13A.

FIG. 14A is a schematic plan view of another conventional optical waveguide; and FIG. 14B is a schematic sectional view taken along the line D-D of FIG. 14A.

### DESCRIPTION OF EMBODIMENTS

Next, embodiments according to the present disclosure will now be described in detail with reference to the drawings.

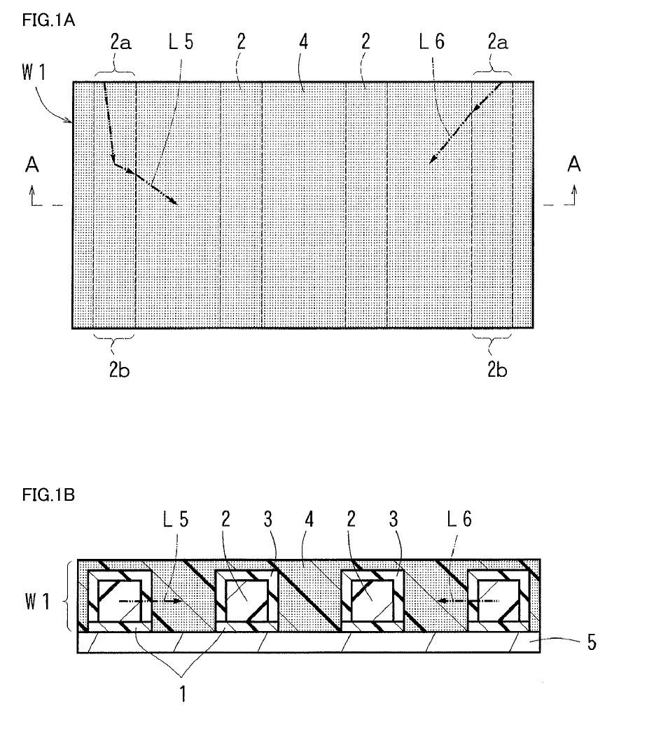

FIG. 1A is a plan view of an optical waveguide W1 according to a first embodiment of the present disclosure, and FIG. 1B is a sectional view taken along the line A-A of FIG. 1A. The optical waveguide W1 according to the first embodiment includes: a plurality of (in the figures, four) strip-shaped under claddings 1 arranged in side-by-side relation; cores 2 for light propagation formed individually on surfaces of the respective under claddings 1 and each extending in a longitudinal direction of the under claddings 1; over claddings 3 formed on the surfaces of the respective under claddings 1 so as to cover the respective cores 2 along side and top surfaces of the respective cores 2; and a light absorbing part 4 integrally formed so as to cover side surfaces of the under claddings 1 and side and top surfaces of the over claddings 3. The light absorbing part 4 contains a light absorbing agent having an ability to absorb light propagating in the cores 2. As shown in FIG. 1A, each of the cores 2 has a first longitudinal end portion serving as a light entrance portion 2a, and a second longitudinal end portion serving as a light exit portion 2b. Light entering the light entrance portion 2a passes through each of the cores 2, and is propagated to the light exit portion 2b. For the purpose of clarifying the arrangement of the cores 2 and the light absorbing part 4 which are principal components, some of the components including the over claddings 3 and the like are not shown in FIG. 1A. In FIG. 1B, the reference numeral 5 designates a substrate for use in the production of the optical waveguide W1.

In the first embodiment, if light leaking from the cores 2 further leaks from the side surfaces of the under claddings 1 and the side and top surfaces of the over claddings 3, the light impinges upon the light absorbing part 4 and is absorbed by the light absorbing part 4. As a result, the light does not enter adjacent ones of the cores 2 (with reference to dash-double-dot arrows L5 and L6). This enhances the suppression of crosstalk.

The reduction in spacing between the cores 2 is achieved by reducing the width of portions of the light absorbing part 4 which lie between adjacent ones of the over claddings 3. In other words, the suppression of crosstalk is also enhanced even when the spacing between the cores 2 is reduced.

The light absorbing part 4 is provided between adjacent ones of the cores 2, with the over claddings 3 interposed between the light absorbing part 4 and the cores 2, and is in non-contacting relationship with the cores 2. This prevents light propagating in the cores 2 from being absorbed and attenuated by the light absorbing part 4 to achieve proper light propagation.

The light absorbing part 4 will be discussed in more detail. Examples of the light absorbing agent include diimonium salts, cyanine dyes, naphthalocyanine dyes, and phthalocyanine dyes. The light absorbing agent contained in the light absorbing part 4 is determined by the wavelength of light to be absorbed (i.e., the wavelength of light propagating in the cores 2). The aforementioned examples of the light absorbing agent are suitable for the absorption of light having a wavelength in the range of 750 to 1000 nm. Examples of a material for the formation of the light absorbing part 4 include photo-curable resins and thermosetting resins. The content of the light absorbing agent is, for example, 0.3 to 2.0 wt. % in the photo-curable resins and 0.5 to 30.0 wt. % in the thermosetting resins. The aforementioned examples of the light absorbing agent may be used either alone or in combination.

An example of a method of manufacturing the optical waveguide W1 will be discussed below in detail.

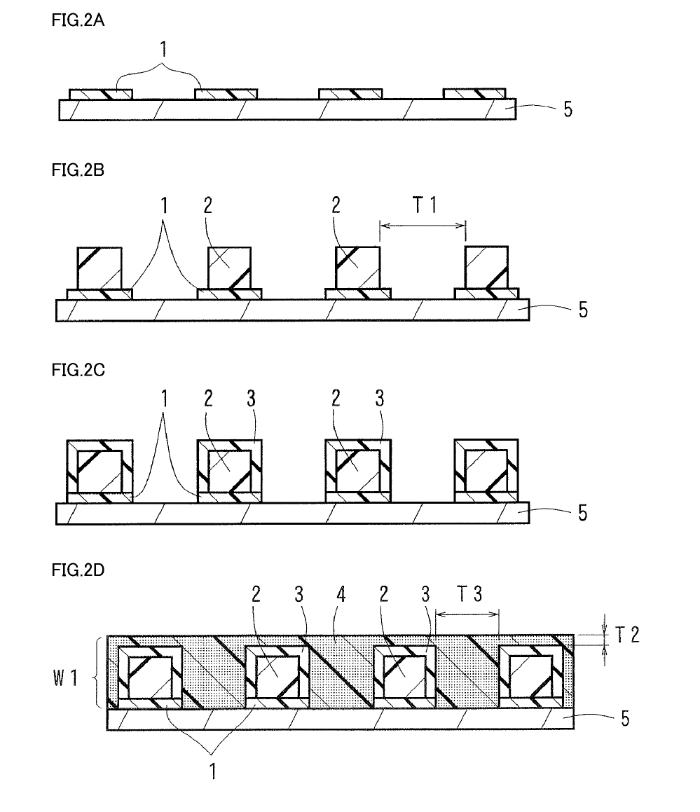

First, the substrate 5 (with reference to FIG. 2A) is prepared. Examples of a material for the formation of the substrate 5 include metal, resin, glass, quartz, and silicon. The substrate 5 has a thickness in the range of 10 to 1000 μm, for example.

Subsequently, as shown in FIG. 2A, the strip-shaped under claddings 1 arranged in side-by-side relation are formed on a surface of the substrate 5 by a photolithographic method with the use of a photosensitive resin that is a material for the formation of the under claddings 1. The under claddings 1 have the following dimensions: a thickness in the range of 5 to 50 μm; a width in the range of 30 to 500 μm; and a gap width of not less than 20 μm between adjacent ones of the under claddings 1, for example.

Next, as shown in FIG. 2B, the cores 2 are formed individually on the surfaces of the respective under claddings 1 by a photolithographic method with the use of a photosensitive resin that is a material for the formation of the cores 2 so as to each extend in a longitudinal direction of the under claddings 1. The cores 2 have the following dimensions: a thickness in the range of 10 to 80 μm; a width in the range of 8 to 90% of the width of the under claddings 1; and a gap width T1 in the range of 20 to 500 μm between adjacent ones of the cores 2, for example. The material used herein for the formation of the cores 2 is a photosensitive resin having a refractive index higher than the refractive indices of the materials for the formation of the aforementioned under claddings 1 and the over claddings 3 to be described below (with reference to FIG. 2C).

Subsequently, as shown in FIG. 2C, the over claddings 3 are formed on the surfaces of the respective under claddings 1 by a photolithographic method with the use of a photosensitive resin that is a material for the formation of the over claddings 3 so as to cover the respective cores 2 along the side and top surfaces of the respective cores 2. Portions of the over claddings 3 which cover the side surfaces of the cores 2 have a thickness in the range of 3 to 500 μm, and portions of the over claddings 3 which cover the top surfaces of the cores 2 have a thickness in the range of 3 to 50 μm, for example.

Then, as shown in FIG. 2D, the light absorbing part 4 is integrally formed on the surface of the substrate 5 so as to cover the side surfaces of the under claddings 1 and the side and top surfaces of the over claddings 3. This light absorbing part 4 is formed by a manufacturing method depending on the material (photo-curable resins, thermosetting resins, and the like) for the formation of the light absorbing part 4. The light absorbing part 4 has the following dimensions: a thickness T2 in the range of greater than 0 (zero) to 200 μm as measured from the top surfaces of the over claddings 3; and a width T3 in the range of greater than 0 (zero) to 400 μm, preferably in the range of 10 to 250 μm, in portions present between adjacent ones of the over claddings 3, for example.

In this manner, the optical waveguide W1 including the under claddings 1, the cores 2, the over claddings 3, and the light absorbing part 4 is produced on the surface of the substrate 5. This optical waveguide W1 may be used in contact with the surface of the substrate 5 or separate from the substrate 5.

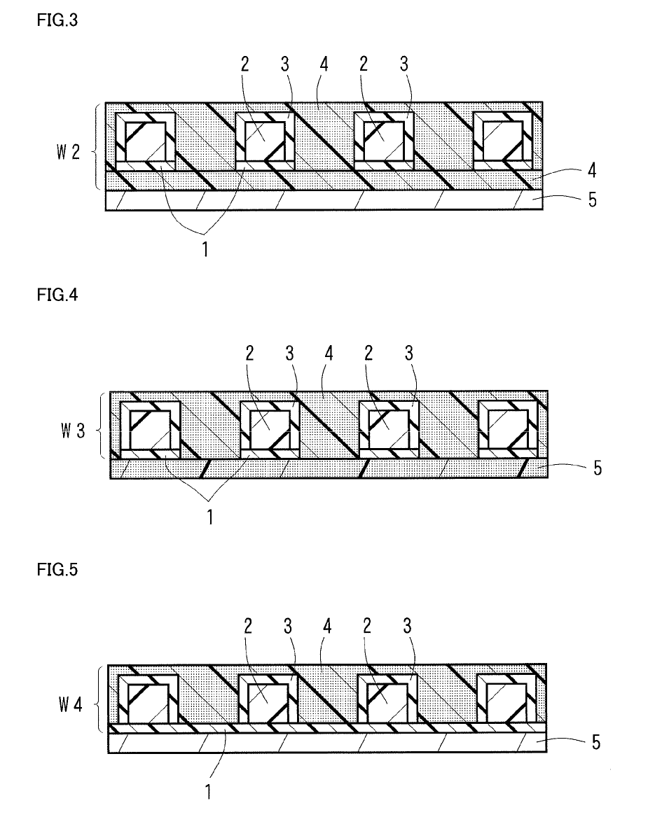

FIG. 3 is a sectional view (a sectional view corresponding to FIG. 1B) of an optical waveguide W2 according to a second embodiment of the present disclosure. The second embodiment is configured such that a layer of the light absorbing part 4 is provided also between the under claddings 1 and the substrate 5 in the first embodiment shown in FIGS. 1A and 1B. Specifically, one layer of the light absorbing part 4 is formed on the surface of the substrate 5, and the under claddings 1 are formed on a surface of the layer of the light absorbing part 4. The layer of the light absorbing part 4 is also a component of the optical waveguide W2. The remaining parts of the second embodiment are similar to those of the first embodiment shown in FIGS. 1A and 1B, and like reference numerals and characters are used to designate similar parts.

The second embodiment is capable of absorbing light leaking from bottom surfaces of the under claddings 1 by means of the layer of the light absorbing part 4 provided between the under claddings 1 and the substrate 5 in addition to producing the light absorbing effect of the light absorbing part 4 as in the first embodiment. This further enhances the suppression of crosstalk.

FIG. 4 is a sectional view (a sectional view corresponding to FIG. 1B) of an optical waveguide W3 according to a third embodiment of the present disclosure. The third embodiment is configured such that the substrate 5 is made of the material for the formation of the light absorbing part 4 in the first embodiment shown in FIGS. 1A and 1B. In the third embodiment, the optical waveguide W3 is used in contact with the surface of the substrate 5. The remaining parts of the third embodiment are similar to those of the first embodiment shown in FIGS. 1A and 1B, and like reference numerals and characters are used to designate similar parts.

The third embodiment is capable of absorbing light leaking from the bottom surfaces of the under claddings 1 by means of the substrate 5 in addition to producing the light absorbing effect of the light absorbing part 4 as in the first embodiment. This further enhances the suppression of crosstalk.

FIG. 5 is a sectional view (a sectional view corresponding to FIG. 1B) of an optical waveguide W4 according to a fourth embodiment of the present disclosure. The fourth embodiment is configured such that an under cladding 1 in the form of an integral layer is formed in place of the strip-shaped under claddings 1 arranged in side-by-side relation in the first embodiment shown in FIGS. 1A and 1B. The light absorbing part 4 is formed on surface portions of the under cladding 1 other than where the cores 2 and the over claddings 3 are formed. The remaining parts of the fourth embodiment are similar to those of the first embodiment shown in FIGS. 1A and 1B, and like reference numerals and characters are used to designate similar parts.

In the fourth embodiment, if light leaking from the cores 2 further leaks from the side and top surfaces of the over claddings 3, the light impinges upon the light absorbing part 4 and is absorbed by the light absorbing part 4. This enhances the suppression of crosstalk.

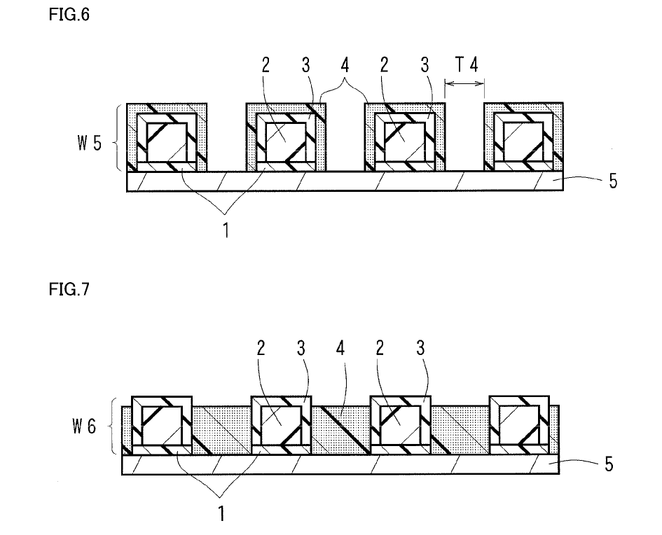

FIG. 6 is a sectional view (a sectional view corresponding to FIG. 1B) of an optical waveguide W5 according to a fifth embodiment of the present disclosure. The fifth embodiment is configured such that light absorbing parts 4 are formed individually in corresponding relation to the cores 2 in the first embodiment shown in FIGS. 1A and 1B. Specifically, gaps are provided between adjacent ones of the light absorbing parts 4, and the light absorbing parts 4 cover the side surfaces of the respective under claddings land the side and top surfaces of the respective over claddings 3. In the fifth embodiment, the optical waveguide W5 is used in contact with the surface of the substrate 5. The remaining parts of the fifth embodiment are similar to those of the first embodiment shown in FIGS. 1A and 1B, and like reference numerals and characters are used to designate similar parts.

The fifth embodiment produces the light absorbing effect of the light absorbing parts 4 as in the first embodiment. Further, side and top surfaces of the light absorbing parts 4 are in contact with air, and the refractive index of the light absorbing parts 4 is in general higher than that of air. For this reason, light in the light absorbing parts 4 is less prone to leak from the light absorbing parts 4 toward outside air. This further enhances the suppression of crosstalk.

The gaps between adjacent ones of the light absorbing parts 4 are formed by patterning the light absorbing part 4 by means of a photolithographic method in the step of forming the light absorbing part 4 (with reference to FIG. 2D). Alternatively, the gaps may be formed by cutting the light absorbing part 4 of the optical waveguide W1 of the first embodiment shown in FIGS. 1A and 1B. The gaps have a width T4 required only to exceed 0 (zero), preferably in the range of 5 to 200 μm.

FIG. 7 is a sectional view (a sectional view corresponding to FIG. 1B) of an optical waveguide W6 according to a sixth embodiment of the present disclosure. The sixth embodiment is configured such that the light absorbing part 4 in the first embodiment shown in FIGS. 1A and 1B is made thinner so as not to cover the top surfaces of the over claddings 3. In the sixth embodiment, the vertical position of a surface of the light absorbing part 4 is higher than that of bottom surfaces of the cores 2 (the vertical position of the surfaces of the under claddings 1). The remaining parts of the sixth embodiment are similar to those of the first embodiment shown in FIGS. 1A and 1B, and like reference numerals and characters are used to designate similar parts.

In the sixth embodiment, if light leaking from the cores 2 further leaks from the side surfaces of the under claddings 1 and the side and top surfaces of the over claddings 3, part of the light impinges upon the light absorbing part 4 and is absorbed by the light absorbing part 4. This enhances the suppression of crosstalk.

In the sixth embodiment, it is preferable that the vertical position of the surface of the light absorbing part 4 is level with the vertical position of the top surfaces of the cores 2, as shown in FIG. 7, from the viewpoint of further enhancing the suppression of crosstalk. The vertical position of the surface of the light absorbing part 4 may be higher than the vertical position of the top surfaces of the cores 2.

In the second to fifth embodiments, the vertical position of the surfaces of the light absorbing parts 4 may be determined as in the sixth embodiment.

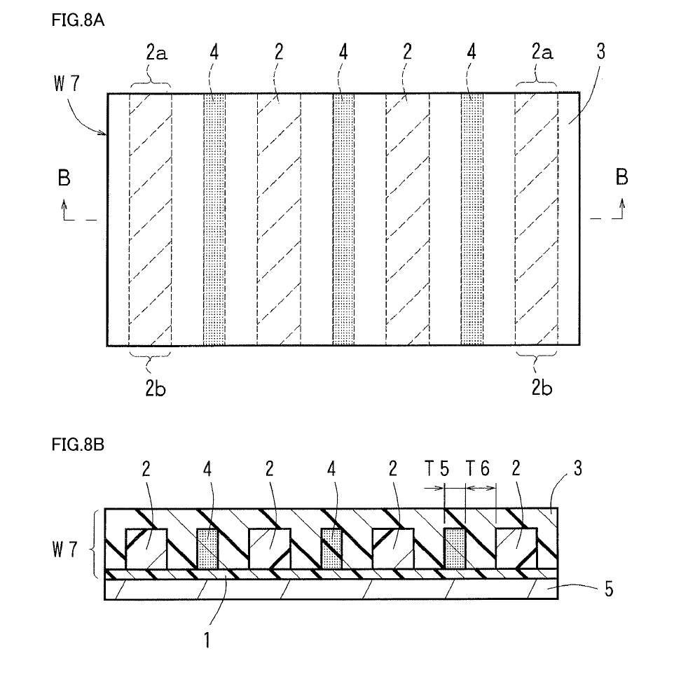

FIG. 8A a plan view of an optical waveguide W7 according to a seventh embodiment of the present disclosure, and FIG. 8B is a sectional view taken along the line B-B of FIG. 8A. The optical waveguide W7 according to the seventh embodiment includes: the under cladding 1 in the form of one layer; the plurality of (in the figures, four) linear cores 2 formed in predetermined positions on the surface of the under cladding 1 and arranged in side-by-side relation; the linear light absorbing parts 4 formed on surface portions of the under cladding 1 which lie between adjacent ones of the cores 2 and arranged in parallel non-contacting relationship with the cores 2; and an over cladding 3 formed on the surface of the under cladding 1 so as to cover the cores 2 and the light absorbing parts 4. In the seventh embodiment, the cores 2 and the light absorbing parts 4 have the same thickness. The remaining parts of the seventh embodiment are similar to those of the first embodiment shown in FIGS. 1A and 1B, and like reference numerals and characters are used to designate similar parts. For the purpose of clarifying the arrangement of the cores 2 and the light absorbing parts 4 which are principal components, the cores 2 are shaded by means of broken diagonal lines in FIG. 8A.

In the seventh embodiment, if light leaking from the cores 2 is directed toward adjacent ones of the cores 2, the light impinges upon the light absorbing parts 4 and is absorbed by the light absorbing parts 4. This enhances the suppression of crosstalk.

The light absorbing parts 4 in the seventh embodiment are formed to have a volume smaller than the volumes of the light absorbing parts 4 in the first to sixth embodiments. The seventh embodiment accordingly achieves savings in the material for the formation of the light absorbing parts 4.

A method of manufacturing the optical waveguide W7 according to the seventh embodiment is as follows. First, the under cladding 1 is formed on the surface of the substrate 5. Subsequently, the cores 2 are formed on the surface of the under cladding 1. Next, the light absorbing parts 4 are formed on the surface of the under cladding 1, with gaps provided between the light absorbing parts 4 and the cores 2. Then, the over cladding 3 is formed on the surface of the under cladding 1 so as to cover the cores 2 and the light absorbing parts 4. In this manner, the optical waveguide W7 is produced on the surface of the substrate 5. The process of forming the cores 2 and the process of forming the light absorbing parts 4 may be performed in the reverse order. The light absorbing parts 4 have a width T5 required only to exceed 0 (zero), preferably in the range of 10 to 250 μm. The gaps between the cores 2 and the light absorbing parts 4 which are adjacent to each other have a width T6 required only to exceed 0 (zero), preferably in the range of 5 to 200 μm.

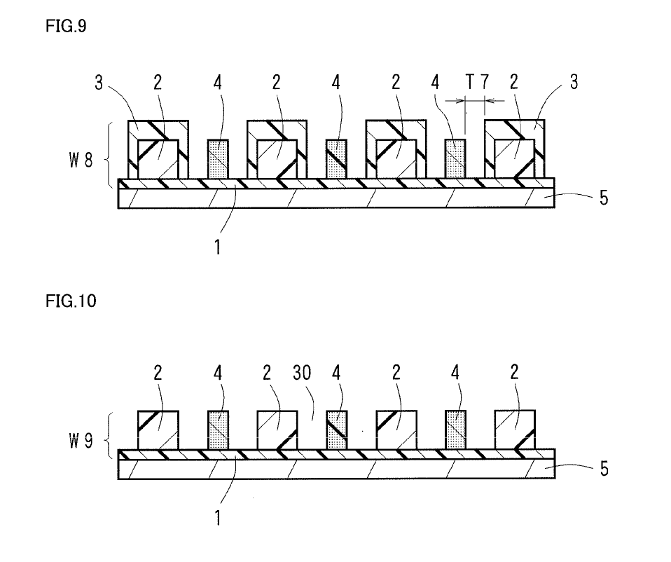

FIG. 9 is a sectional view (a sectional view corresponding to FIG. 8B) of an optical waveguide W8 according to an eighth embodiment of the present disclosure. The eighth embodiment is configured such that the over claddings 3 are formed individually in corresponding relation to the cores 2 in the seventh embodiment shown in FIGS. 8A and 8B. Specifically, each of the cores 2 is covered with one of the over claddings 3, and the light absorbing parts 4 are not covered with the over claddings 3. In the eighth embodiment, gaps are provided between the over claddings 3 and the light absorbing parts 4 which are adjacent to each other. The remaining parts of the eighth embodiment are similar to those of the seventh embodiment shown in FIGS. 8A and 8B, and like reference numerals and characters are used to designate similar parts.

The eighth embodiment produces the light absorbing effect of the light absorbing parts 4 as in the seventh embodiment. Further, the side and top surfaces of the over claddings 3 are in contact with air, and the refractive index of the over claddings 3 is higher than that of air. For this reason, light in the over claddings 3 is less prone to leak from the over claddings 3 toward outside air. This further enhances the suppression of crosstalk.

The gaps between the over claddings 3 and the light absorbing parts 4 which are adjacent to each other are formed by patterning the over cladding 3 by means of a photolithographic method in the method of manufacturing the optical waveguide W7 of the seventh embodiment shown in FIGS. 8A and 8B. The gaps have a width T7 required only to exceed 0 (zero), preferably in the range of 5 to 200 μm.

In the seventh and eighth embodiments, the thickness of the light absorbing parts 4 is equal to that of the cores 2. However, the thickness of the light absorbing parts 4 is required only to exceed 0 (zero). An upper limit to the thickness of the light absorbing parts 4 may be less than the thickness of the cores 2 or greater than the thickness of the cores 2.

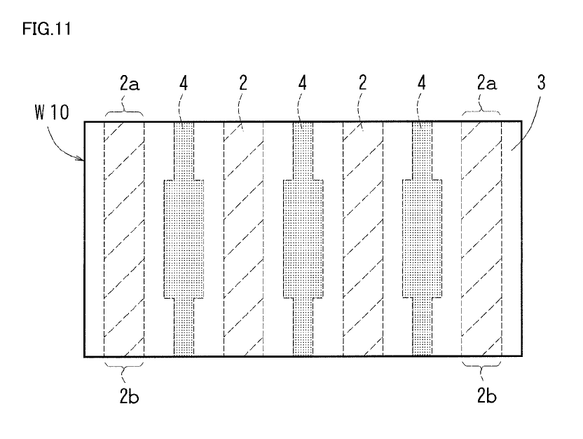

The over claddings 3 made of a resin are formed in the seventh and eighth embodiments. However, the over claddings 3 need not be formed as in an optical waveguide W9 shown in sectional view (sectional view corresponding to FIG. 8B) in FIG. 10. Specifically, a cladding (air cladding) 30 made of air may be used in place of the over claddings 3 made of a resin. This provides a greater difference in refractive index between the cores 2 and air (air cladding 30) to make light propagating in the cores 2 less prone to leak from the cores 2, thereby further enhancing the suppression of crosstalk.

The linear light absorbing parts 4 have a uniform width in the longitudinal direction thereof in the seventh and eighth embodiments (with reference to FIG. 8A), but need not have a uniform width. For example, the light absorbing parts 4 may have an intermittently greater width in a longitudinally middle portion thereof as in an optical waveguide W10 shown in plan view in FIG. 11 or may have a width gradually increasing toward the longitudinally middle portion thereof (not shown). In contrast to this, the light absorbing parts 4 may have a greater width in longitudinally opposite end portions thereof. It should be noted that a modification of the seventh embodiment (with reference to FIG. 8A) is shown in FIG. 11.

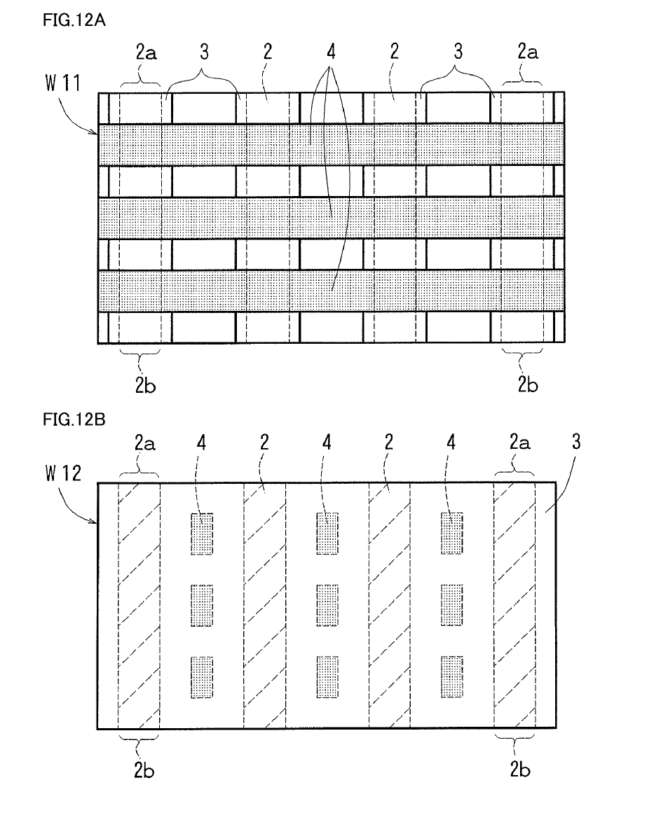

The light absorbing parts 4 are formed to extend continuously from one longitudinal end to the other longitudinal end of the optical waveguides W1 to W10 in the first to eighth embodiments, but may be formed intermittently as in optical waveguides W11 and W12 shown in plan view in FIGS. 12A and 12B. It should be noted that a modification of the first embodiment (with reference to FIG. 1A) is shown in FIG. 12A, and a modification of the seventh embodiment (with reference to FIG. 8A) is shown in FIG. 12B.

Next, inventive examples of the present disclosure will be described in conjunction with a conventional example. It should be noted that the present disclosure is not limited to the inventive examples.

### EXAMPLES

[Material for Formation of Under Cladding and Over Cladding]

Component a: 70 g of an epoxy resin (jER1001 available from Mitsubishi Chemical Corporation).

Component b: 20 g of an epoxy resin (EHPE3150 available from Daicel Corporation).

Component c: 10 g of an epoxy resin (EXA-4816 available from DIC Corporation).

Component d: 0.5 g of a photo-acid generator (CPI-101A available from San-Apro Ltd.).

Component e: 0.5 g of an antioxidant (Songnox1010 available from Kyodo Chemical Co., Ltd.).

Component f: 0.5 g of an antioxidant (HCA available from Sanko Co., Ltd.).

Component g: 50 g of ethyl lactate (a solvent).

A material for the formation of an under cladding and an over cladding was prepared by mixing these components a to g together.

[Material for Formation of Cores]

Component h: 50 g of an epoxy resin (YDCN-700-3 available from Nippon Steel & Sumikin Chemical Co., Ltd.).

Component i: 30 g of an epoxy resin (jER1002 available from Mitsubishi Chemical Corporation).

Component j: 20 g of an epoxy resin (OGSOL PG-100 available from Osaka Gas Chemicals Co., Ltd.).

Component k: 0.5 g of a photo-acid generator (CPI-101A available from San-Apro Ltd.).

Component 1: 0.5 g of an antioxidant (Songnox1010 available from Kyodo Chemical Co., Ltd.).

Component m: 0.125 g of an antioxidant (HCA available from Sanko Co., Ltd.).

Component n: 50 g of ethyl lactate (a solvent).

A material for the formation of cores was prepared by mixing these components h to n together.

[Material for Formation of Light Absorbing Part]

Component o: 50 g of an epoxy resin (YDCN-700-3 available from Nippon Steel & Sumikin Chemical Co., Ltd.).

Component p: 30 g of an epoxy resin (jER1002 available from Mitsubishi Chemical Corporation).

Component q: 20 g of an epoxy resin (OGSOL PG-100 available from Osaka Gas Chemicals Co., Ltd.).

Component r: 0.5 g of a photo-acid generator (CPI-101A available from San-Apro Ltd.).

Component s: 2.26 g of a light absorbing agent (NT-MB-IRL3801 available from Nitto Denko Corporation).

Component t: 50 g of ethyl lactate (a solvent).

A material for the formation of a light absorbing part was prepared by mixing these components o to t together.

### Inventive Example 1

Using the aforementioned materials, the optical waveguide (having a length of 50 mm) of the first embodiment shown in FIGS. 1A and 1B was produced on a surface of a substrate made of a resin. The under claddings had the following dimensions: a thickness of 40 μm; a width of 100 μm; and a gap width of 150 μm between adjacent ones of the under claddings. The cores had the following dimensions: a thickness of 40 μm; a width of 40 μm; and a spacing of 250 μm therebetween. Portions of the over claddings which covered the side surfaces of the cores had a thickness of 30 μm, and portions of the over claddings which covered the top surfaces of the cores had a thickness of 30 μm. The light absorbing part had the following dimensions: a width of 150 μm in portions present between adjacent ones of the over claddings; and a thickness of 15 μm as measured from the top surfaces of the over claddings.

### Inventive Example 2

Using the aforementioned materials, the optical waveguide (having a length of 50 mm) of the second embodiment shown in FIG. 3 was produced on a surface of a substrate made of a resin. The layer of the light absorbing part provided between the under claddings and the substrate had a thickness of 20 μm. The remaining parts had the same dimensions as those in Inventive Example 1.

### Inventive Example 3

Using the aforementioned materials, the optical waveguide (having a length of 50 mm) of the fourth embodiment shown in FIG. 5 was produced on a surface of a substrate made of a resin. The components including the cores had the same dimensions as those in Inventive Example 1.

### Inventive Example 4

Using the aforementioned materials, the optical waveguide (having a length of 50 mm) of the fifth embodiment shown in FIG. 6 was produced on a surface of a substrate made of a resin. The gaps between adjacent ones of the light absorbing parts had a width of 50 μm. The remaining parts had the same dimensions as those in Inventive Example 1.

### Inventive Example 5

Using the aforementioned materials, the optical waveguide (having a length of 50 mm) of the seventh embodiment shown in FIGS. 8A and 8B was produced on a surface of a substrate made of a resin. The light absorbing parts had the following dimensions: a width of 150 μm; and a thickness of 40 μm. The gaps between the light absorbing parts and the cores which were adjacent to each other had a width of 30 μm. The remaining parts had the same dimensions as those in Inventive Example 1.

### Inventive Example 6

Using the aforementioned materials, the optical waveguide (having a length of 50 mm) of the eighth embodiment shown in FIG. 9 was produced on a surface of a substrate made of a resin. The light absorbing parts had the following dimensions: a width of 100 μm; and a thickness of 40 μm. The gaps between the over claddings and the light absorbing parts which were adjacent to each other had a width of 25 μm. The remaining parts had the same dimensions as those in Inventive Example 1.

### Inventive Example 7

The material for the formation of the light absorbing part in Inventive Example 1 was changed to a thermosetting material to be described below. The remaining parts were the same as those in Inventive Example 1.

### Inventive Example 8

The material for the formation of the light absorbing part in Inventive Example 2 was changed to a thermosetting material to be described below. The remaining parts were the same as those in Inventive Example 2.

[Thermosetting Material for Formation of Light Absorbing Part]

An epoxy resin (NT-8038 available from Nitto Denko Corporation) of the type in which a first liquid (resin) and a second liquid (curing agent) were mixed was prepared. Then, 50 g of the first liquid, 50 g of the second liquid, and 11 g of the light absorbing agent that was the aforementioned component s were mixed together to prepare the thermosetting material for the formation of the light absorbing part.

### Conventional Example

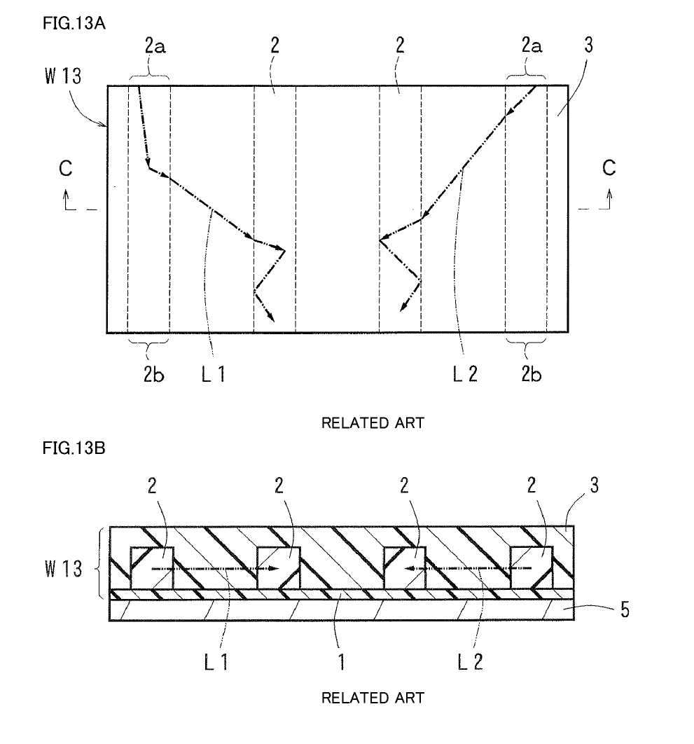

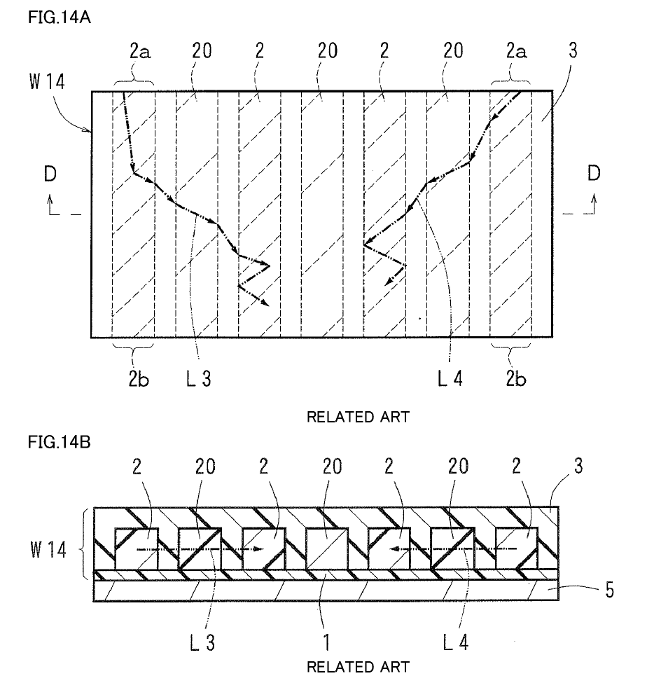

Using the aforementioned materials, a conventional optical waveguide (having a length of 50 mm) shown in FIGS. 13A and 13B in which no light absorbing parts were provided was produced on a surface of a substrate made of a resin. The over cladding had a thickness of 30 μm as measured from the top surfaces of the cores. The remaining parts had the same dimensions as those in Inventive Example 1.

[Calculation of Crosstalk Suppressing Value]

Prepared were a graded index (GI) type multimode optical fiber (a first optical fiber) having a diameter of 50 μm and connected to a VCSEL light source (OP250-LS-850-MM50-SC available from Miki Inc. and having an emission wavelength of 850 nm), and a step-index (SI) multimode optical fiber (a second optical fiber) having a diameter of 105 μm and connected to an optical power meter (Q8221 available from Advantest Corporation). Then, a front end of the first optical fiber and a front end of the second optical fiber were brought into abutment with each other. The optical power meter received light coming from the VCSEL light source to measure the intensity (I₀) of the received light.

Subsequently, the front end of the first optical fiber was temporarily connected to a light entrance portion (a first end portion) of one of the cores in the optical waveguide of each of Inventive Examples 1 to 8 and Conventional Example. The front end of the second optical fiber was temporarily connected to a light exit portion (a second end portion) of the one core. The optical power meter received light coming from the VCSEL light source while the positions of the front ends of both of the optical fibers were changed. At a position where the intensity of the received light was at a maximum, the front end of the first optical fiber was fixed to the light entrance portion (the first end portion) of the one core. This achieved the positioning of the first optical fiber aligned with the one core.

Next, the front end of the second optical fiber was connected to the light exit portion (the second end portion) of a core adjacent to the one core. In that state, the optical power meter measured the intensity (I) of the received light. Then, [−10×log(I/I₀)] was calculated from the measured intensities of the received light, and the calculated value was defined as a crosstalk suppressing value. The results were listed in TABLE 1 below.

TABLE 1

| | Inv. Ex. | | | | | | | | Conv. |
|---|---|---|---|---|---|---|---|---|---|
| | 1 | 2 | 3 | 4 | 5 | 6 | 7 | 8 | Ex. |
| Crosstalk | 47 | 47 | 46 | 45 | 45 | 46 | 60 | 60 | 41 |
| suppressing | | | | | | | | | |
| value | | | | | | | | | |

The results in TABLE 1 show that Inventive Examples 1 to 8 in which the light absorbing parts are provided suppress crosstalk more than the Conventional Example in which no light absorbing parts are provided. In particular, it was found that crosstalk is suppressed more excellently in Inventive Examples 7 and 8 in which the thermosetting material is used as the material for the formation of the light absorbing part.

The optical waveguide of the third embodiment shown in FIG. 4, the optical waveguide of the sixth embodiment shown in FIG. 7, and the modifications of the optical waveguides shown in FIGS. 10, 11, 12A, and 12B also attained results having tendencies similar to those in the Inventive Examples described above.

Although specific forms in the present disclosure have been described in the aforementioned examples, the aforementioned examples should be considered as merely illustrative and not restrictive. It is contemplated that various modifications evident to those skilled in the art could be made without departing from the scope of the present disclosure.

The optical waveguide according to the present disclosure is usable for enhancing the suppression of crosstalk.

### REFERENCE SIGNS LIST

W1 Optical waveguide
1 Under claddings
2 Cores
3 Over claddings
4 Light absorbing parts
5 Substrate

1. An optical waveguide, comprising:
a plurality of cores for light propagation arranged in side-by-side relation; and
a light absorbing part provided between adjacent ones of the plurality of cores, the light absorbing part being in a non-contacting relationship with the cores,
wherein the light absorbing part contains a light absorbing agent having an ability to absorb light propagating in the cores.

2. The optical waveguide according to claim 1, wherein the non-contacting relationship between the cores and the light absorbing part is established by a cladding surrounding the cores.

3. The optical waveguide according to claim 2, wherein the cladding is made of a resin.

4. The optical waveguide according to claim 3, wherein the cladding is covered with the light absorbing part.

5. The optical waveguide according to claim 2, wherein the cladding is made of air.
